(19) United States
(12) Patent Application Publication
(10) Pub. No.: US 2012/0269391 A1
(43) Pub. Date: Oct. 25, 2012

(54) ENVIRONMENT RECOGNITION DEVICE AND ENVIRONMENT RECOGNITION METHOD

(75) Inventor: Toru Saito, Tokyo (JP)

(73) Assignee: FUJI JUKOGYO KABUSHIKI KAISHA, Tokyo (JP)

(21) Appl. No.: 13/451,745

(22) Filed: Apr. 20, 2012

(30) Foreign Application Priority Data
Apr. 22, 2011 (JP) 2011-096067

(51) Int. Cl. G06K 9/00

(52) U.S. Cl. 382/103; 382/106

(57) ABSTRACT

An environment recognition device obtains a luminance of a target portion existing in a detection area, obtains a height of the target portion, and provisionally determines a specific object corresponding to the target portion or determines a specific object corresponding to grouped target objects, according to the luminance and the height of the target portion based on the association (specific object table) of a range of luminance and a range of height from a road surface with the specific object which is retained in a data retaining unit.

### CROSS-REFERENCE TO RELATED APPLICATIONS

The present application claims priority from Japanese Patent Application No. 2011-096067 filed on Apr. 22, 2011, the entire contents of which are hereby incorporated by reference.

### BACKGROUND OF THE INVENTION

1. Field of the Invention

The present invention relates to an environment recognition device and an environment recognition method for recognizing a target object based on luminances of the target object in a detection area.

2. Description of Related Art

Conventionally, a technique has been known that detects a target object such as an obstacle including a vehicle and a traffic light located in front of a subject vehicle for performing control to avoid collision with the detected target object and to maintain a safe distance between the subject vehicle and the preceding vehicle (for example, Japanese Patent No. 3349060 (Japanese Patent Application Laid-Open (JP-A) No. 10-283461).

Further, in such techniques, there is a technique that performs more advanced control. Specifically, it not only specifies a target object uniformly as a solid object, but further determines whether the detected target object is a preceding vehicle that is running at the same speed as the subject vehicle or a fixed object that does not move. In this case, when the target object is detected by capturing an image of a detection area, it is necessary to extract (cut out) the target object from the captured image before specifying what the target object is.

For example, when the captured image is a color image, there may be a method for extracting, as a target object, a set of pixels having a same luminance (color). However, when the colors of the target object and the background are close and it is impossible to distinguish them from each other based on the luminances thereof, or when the target object is not constituted by a single color, an integrated target object may be specified as a plurality of separate portions. Accordingly, as a technique for calculating a feature quantity of such target object, there is a technique that groups a plurality of pixels having a similar color characteristic and simplifying the image (for example, JP-A No. 2000-67240).

However, in the conventional method, luminance information on each pixel is extracted from the entire captured image, and on every such occasion, processing is performed to group close pixels. This takes a vast amount of processing time to complete the processing of the entire image. Moreover, in some cases, pixels unnecessary for the control are grouped uselessly, thereby reducing the efficiency and accuracy of specifying the target object.

### BRIEF SUMMARY OF THE INVENTION

In view of such problems, it is an object of the present invention to provide an environment recognition device and an environment recognition method that improve the efficiency and accuracy of specifying a target object and that reduce the processing time.

In order to solve the above problems, an aspect of the present invention provides an environment recognition device that includes: a data retaining unit that retains a range of luminance and a range of height from a road surface in association with a specific object; a luminance obtaining unit that obtains a luminance of a target portion in a detection area of a luminance image, a position information obtaining unit that obtains a height of the target portion, and a specific object provisional determining unit that provisionally determines the specific object corresponding to the target portion from the luminance and the height of the target portion on the basis of the association retained in the data retaining unit.

The position information obtaining unit may obtain a distance image that is associated with the detection area of the luminance image and includes a relative distance of the target portion in the detection area with respect to a subject vehicle, and may derive the height of the target portion on the basis of the relative distance of the target portion and a detection distance in the distance image between a point on a road surface located at the same relative distance as the target portion and the target portion.

The environment recognition device may further include a grouping unit that groups target portions, of which position differences in the width direction and a difference in the height direction are within a predetermined range and which are provisionally determined to correspond to a same specific object into a target object and a specific object determining unit that determines the target object is the specific object.

The grouping unit may group target portions of which relative-distance difference is within a predetermined range and which are provisionally determined to correspond to a same specific object.

The data retaining unit may further retain a range of size in association with the specific object, and the specific object determining unit may determine that the target object is the specific object according to the size of the target object on the basis of the association retained in the data retaining unit.

The specific object provisional determining unit may determine whether or not one of the specific objects sequentially selected from a plurality of specific objects corresponds to each of target portions, and provisionally determine a specific object corresponding to the target portion.

In order to solve the above problems, another aspect of the present invention provides an environment recognition method that includes: obtaining a luminance of a target portion in a detection area of a luminance image; obtaining a height of the target portion; and provisionally determining a specific object corresponding to the target portion from the luminance and the height of the target portion based on the association of a range of luminance and a range of height from a road surface according to the specific object, which is retained in a data retaining unit.

According to the present invention, a target object is specified by a plurality of parameters such as luminance and height, and therefore, the efficiency and accuracy of specifying the target object can be improved, and the processing time can be reduced.

### BRIEF DESCRIPTION OF THE SEVERAL VIEWS OF THE DRAWINGS

FIG. 1 is a block diagram illustrating a connection relationship in an environment recognition system;

FIGS. 2A and 2B are explanatory diagrams for explaining a luminance image and a distance image;

FIG. 3 is a functional block diagram schematically illustrating functions of an environment recognition device;

FIG. 4 is an explanatory diagram for explaining a specific object table;

FIG. 5 is an explanatory diagram for explaining conversion into three-dimensional position information performed by a position information obtaining unit;

FIG. 6 is an explanatory diagram for explaining a specific object map;

FIG. 7 is a flowchart illustrating an overall flow of an environment recognition method;

FIG. 8 is a flowchart illustrating a flow of specific object map generating processing;

FIG. 9 is a flowchart illustrating a flow of specific object provisional determining processing;

FIG. 10 is a flowchart illustrating a flow of grouping processing; and

FIG. 11 is a flowchart illustrating a flow of specific object determining processing.

### DETAILED DESCRIPTION OF THE INVENTION

A preferred embodiment of the present invention will be hereinafter explained in detail with reference to attached drawings. The size, materials, and other specific numerical values shown in the embodiment are merely exemplification for the sake of easy understanding of the invention, and unless otherwise specified, they do not limit the present invention. In the specification and the drawings, elements having substantially same functions and configurations are denoted with same reference numerals, and repeated explanation thereabout is omitted. Elements not directly related to the present invention are omitted in the drawings.

### (Environment Recognition System 100)

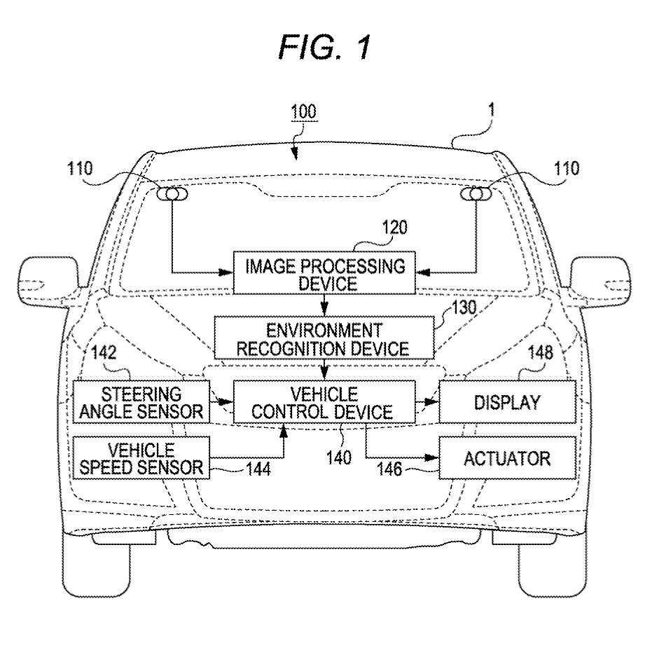

FIG. 1 is a block diagram illustrating connection relationship in an environment recognition system 100. The environment recognition system 100 includes a plurality of image capturing devices 110 (two image capturing devices 110 in the present embodiment), an image processing device 120, an environment recognition device 130, and a vehicle control device 140 that are provided in a vehicle 1.

The image capturing devices 110 include an imaging element such as a CCD (Charge-Coupled Device) and a CMOS (Complementary Metal-Oxide Semiconductor), and can obtain a color image, that is, luminances of three color phases (red, green, blue) per pixel. In this case, a color image captured by the image capturing devices 110 is referred to as luminance image and is distinguished from a distance image to be explained later. The image capturing devices 110 are disposed to be spaced apart from each other in a substantially horizontal direction so that optical axes of the two image capturing devices 110 are substantially parallel in a proceeding direction of the vehicle 1. The image capturing device 110 continuously generates image data obtained by capturing an image of a target object existing in a detection area in front of the vehicle 1 at every 1/60 seconds (60 fps), for example. In this case, the target object may be not only an independent three-dimensional object such as a vehicle, a traffic light, a road, and a guardrail, but also an illuminating portion such as a tail lamp, a turn signal, a traffic light that can be specified as a portion of a three-dimensional object. Each later-described functional unit in the embodiment performs processing in response to the update of such image data.

The image processing device 120 obtains image data from each of the two image capturing devices 110, and derives, based on the two pieces of image data, parallax information including a parallax of any block (a set of a predetermined number of pixels) in the image and a position representing a position of the any block in the image. Specifically, the image processing device 120 derives a parallax using so-called pattern matching that searches a block in one of the image data corresponding to the block optionally extracted from the other image data. The block is, for example, an array including four pixels in the horizontal direction and four pixels in the vertical direction. In this embodiment, the horizontal direction means a horizontal direction for the captured image, and corresponds to the width direction in the real world. On the other hand, the vertical direction means a vertical direction for the captured image, and corresponds to the height direction in the real world.

One way of performing the pattern matching is to compare luminance values (Y color difference signals) between two image data by the block indicating any image position. Examples include an SAD (Sum of Absolute Difference) obtaining a difference of luminance values, an SSD (Sum of Squared intensity Difference) squaring a difference, and an NCC (Normalized Cross Correlation) adopting the degree of similarity of dispersion values obtained by subtracting a mean luminance value from a luminance value of each pixel. The image processing device 120 performs such parallax deriving processing on all the blocks appearing in the detection area (for example, 600 pixels×200 pixels). In this case, the block is assumed to include 4 pixels×4 pixels, but the number of pixels in the block may be set at any value.

Although the image processing device 120 can derive a parallax for each block serving as a detection resolution unit, it is impossible to recognize what kind of target object the block belongs to. Therefore, the parallax information is not derived by the target object, but is independently derived by the resolution (for example, by the block) in the detection area. In this embodiment, an image obtained by associating the parallax information thus derived (corresponding to a later-described relative distance) with image data is referred to as a distance image.

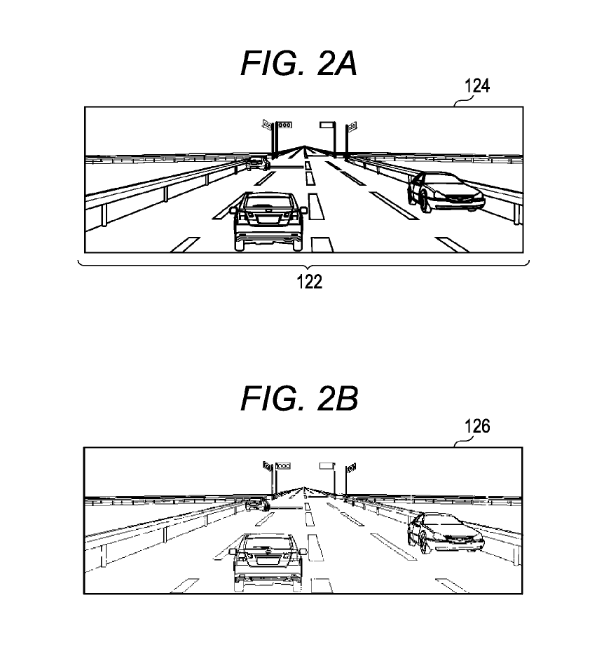

FIGS. 2A and 2B are explanatory diagrams for explaining a luminance image 124 and a distance image 126. For example, Assume that the luminance image (image data) 124 as shown in FIG. 2A is generated with regard to a detection area 122 by the two image capturing devices 110. Here, for the sake of easy understanding, only one of the two luminance images 124 is schematically shown. The image processing device 120 obtains a parallax for each block from such luminance image 124, and forms the distance image 126 as shown in FIG. 2B. Each block of the distance image 126 is associated with a parallax of the block. In the drawing, for the sake of explanation, a block from which a parallax is derived is indicated by a black dot.

The parallax can be easily specified at the edge portion (portion where there is contrast between adjacent pixels) of objects, and therefore, the block from which parallax is derived, which is denoted with black dots in the distance image 126, is likely to also be an edge in the luminance image 124. Therefore, the luminance image 124 as shown in FIG. 2A and the distance image 126 as shown in FIG. 2B are similar in terms of outline of each target object.

The environment recognition device 130 obtains the luminance image 124 and the distance image 126 from the image processing device 120, and uses the luminance based on the luminance image 124 and the height from the road surface based on the distance image 126 (hereinafter simply referred to as “height”) to determine which specific object the target object in the detection area corresponds to. In this embodiment, the environment recognition device 130 uses a so-called stereo method to convert the parallax information for each block in the detection area 122 of the distance image 126 into three-dimensional position information including a relative distance, thereby deriving heights. The stereo method is a method using a triangulation method to derive a relative distance of a target object with respect to the image capturing device 110 from the parallax of the target object. The environment recognition device 130 will be explained later in detail.

The vehicle control device 140 avoids a collision with the target object specified by the environment recognition device 130 and performs control so as to maintain a safe distance from the preceding vehicle. More specifically, the vehicle control device 140 obtains a current cruising state of the vehicle 1 based on, for example, a steering angle sensor 142 for detecting an angle of the steering and a vehicle speed sensor 144 for detecting a speed of the vehicle 1, thereby controlling an actuator 146 to maintain a safe distance from the preceding vehicle. The actuator 146 is an actuator for vehicle control used to control a brake, a throttle valve, a steering angle and the like. When collision with a target object is expected, the vehicle control device 140 displays a warning (notification) of the expected collision on a display 148 provided in front of a driver, and controls the actuator 146 to automatically decelerate the vehicle 1. The vehicle control device 140 can also be integrally implemented with the environment recognition device 130.

### (Environment Recognition Device 130)

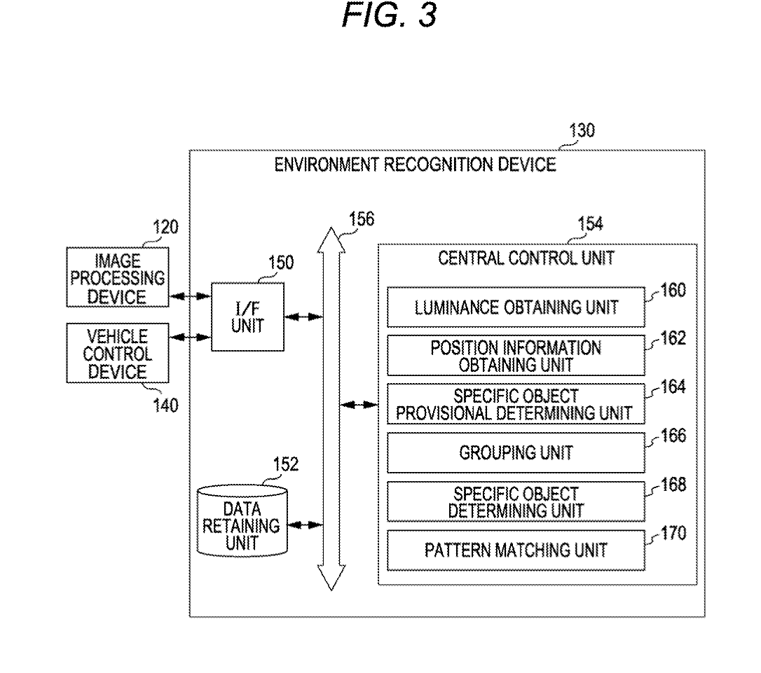

FIG. 3 is a functional block diagram schematically illustrating functions of an environment recognition device 130. As shown in FIG. 3, the environment recognition device 130 includes an I/F unit 150, a data retaining unit 152, and a central control unit 154.

The I/F unit 150 is an interface for interactive information exchange with the image processing device 120 and the vehicle control device 140. The data retaining unit 152 is constituted by a RAM, a flash memory, an HDD and the like, and retains a specific object table (association) and various kinds of information required for processing performed by each functional unit explained below. In addition, the data retaining unit 152 temporarily retains the luminance image 124 and the distance image 126 received from the image processing device 120. The specific object table is used as follows.

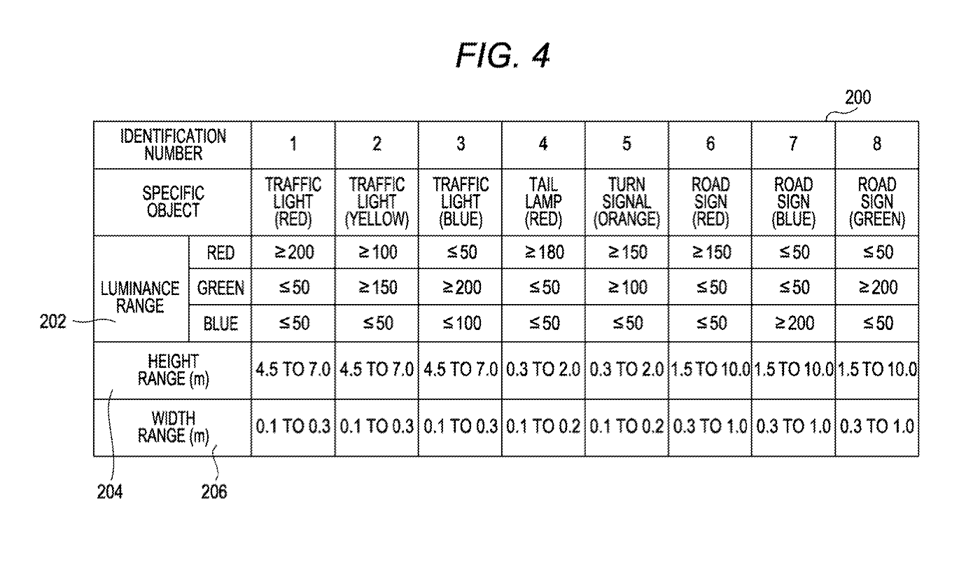

FIG. 4 is an explanatory diagram for explaining a specific object table 200. In the specific object table 200, a plurality of specific objects are associated with a luminance range 202 indicating a range of luminance, a height range 204 indicating a range of height from the road surface, and a width range 206 indicating a range of size of the specific objects. The specific objects include various objects required to be observed while the vehicle runs on the road, such as “traffic light (red)”, “traffic light (yellow)”, “traffic light (blue)”, “tail lamp (red)”, “turn signal (orange)”, “road sign (red)”, “road sign (blue)”, and “road sign (green)”. It is to be understood that the specific object is not limited to the objects in FIG. 4. The specific object table 200 defines the order of priority for specifying a specific object, and the environment recognition processing is performed in accordance with the order of priority for each specific object sequentially selected from the plurality of specific objects in the specific object table 200. Among the specific objects, for example, a specific object “traffic light (red)” is associated with luminance (red) “200 or more”, luminance (green) “50 or less”, luminance (blue) “50 or less”, height range “4.5 to 7.0 m”, and width range “0.1 to 0.3 m”.

In the present embodiment, based on the specific object table 200, any target portion among any target portions in the luminance image 124 that satisfies the condition of the luminance range 202 and the height range 204 with regard to any specific object, and is adopted as a candidate for the specific object. For example, when the luminances of a target portion is included in the luminance range 202 of the specific object “traffic light (red)”, the height of the target portion is derived, and when the height range 204 is included in the height range “4.5 to 7 m” of the object “traffic light (red)”, the target portion is adopted as a candidate for the specific object “traffic light (red)”. Then, when the target object made by grouping the target portions is extracted in a form which appears to be a specific object, for example, when the size of a grouped target object is included in the width range “0.1 to 0.3 m” of the “traffic light (red)”, it is determined to be the specific object. The target portion determined to be the specific object is labeled with an identification number unique to the specific object. Pixel or a block made by collecting pixels may be used as the target portion. Hereafter, in the present embodiment pixels are used the target portion for the sake of convenience of explanation.

The central control unit 154 is comprised of a semiconductor integrated circuit including, for example, a central processing unit (CPU), a ROM storing a program and the like, and a RAM serving as a work area, and controls the I/F unit 150 and the data retaining unit 152 through a system bus 156. In the present embodiment, the central control unit 154 also functions as a luminance obtaining unit 160, a position information obtaining unit 162, a specific object provisional determining unit 164, a grouping unit 166, a specific object determining unit 168, and a pattern matching unit 170.

The luminance obtaining unit 160 obtains luminances by the target portion (pixels) (luminances of three color phases (red, green, and blue) per pixel) from the received luminance image 124 according to a control instruction of the specific object provisional determining unit 164 explained later. At this time, when it is, for example, rainy or cloudy in the detection area, the luminance obtaining unit 160 may obtain the luminances after adjusting white balance so as to obtain the original luminances.

The position information obtaining unit 162 uses the stereo method to convert parallax information for each block in the detection area 122 of the distance image 126 into three-dimensional position information including the width direction x, the height direction y, and the depth direction z according to a control instruction of the specific object provisional determining unit 164 explained later. The parallax information represents a parallax of each target portion in the distance image 126, whereas the three-dimensional position information represents information about the relative distance of each target portion in the real world. Accordingly, a term such as the relative distance and the height refers to a distance in the real world, whereas a term such as a detected distance refers to a distance in the distance image 126. When the parallax information is not derived by the pixel but is derived by the block, that is, a calculation may be executed in units of pixels with the parallax information being deemed as parallax information about all the pixels which belong to a block.

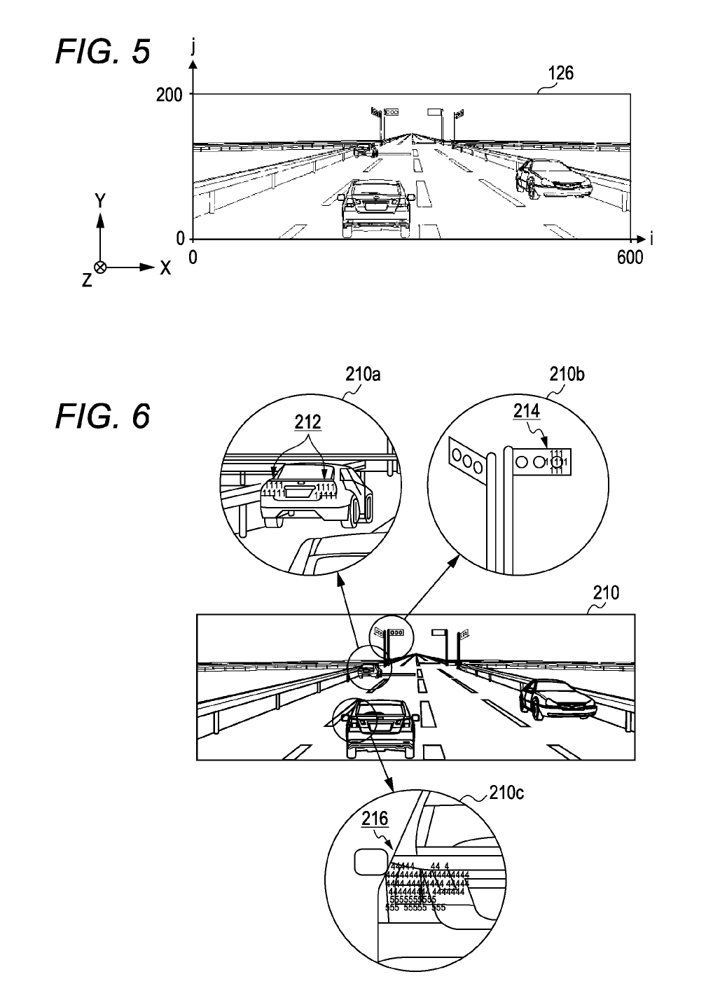

FIG. 5 is an explanatory diagram for explaining conversion into three-dimensional position information by the position information obtaining unit 162. First, the position information obtaining unit 162 treats the distance image 126 as a coordinate system in a pixel unit as shown in FIG. 5. In FIG. 5, the lower left corner is adopted as an origin (0, 0). The horizontal direction is adopted as an i coordinate axis, and the vertical direction is adopted as a j coordinate axis. Therefore, a pixel having a parallax dp can be represented as (i, j, dp) using a pixel position i, j and the parallax dp.

The three-dimensional coordinate system in the real world according to the present embodiment will be considered using a relative coordinate system in which the vehicle 1 is located in the center. The right side of the direction in which the vehicle 1 moves is denoted as a positive direction of X axis, the upper side of the vehicle 1 is denoted as a positive direction of Y axis, the direction in which the vehicle 1 moves (front side) is denoted as a positive direction of Z axis, and the crossing point between the road surface and a vertical line passing through the center of two image capturing devices 110 is denoted as an origin (0, 0, 0). When the road is assumed to be a flat plane, the road surface matches the X-Z plane (y=0). The position information obtaining unit 162 uses (formula 1) to (formula 3) shown below to transform the coordinate of the pixel (i, j, dp) in the distance image 126 into a three-dimensional point (x, y, z) in the real world.

x=CD/2+z·PW·(i−IV) (formula 1)

y=CH+z·PW·(j−JV) (formula 2)

z=KS/dp (formula 3)

Here, CD denotes an interval (baseline length) between the image capturing devices 110, PW denotes a corresponding distance in the real world to a distance between adjacent pixels in the image, so-called like an angle of view per pixel, CH denotes an disposed height of the image capturing device 110 from the road surface, IV and JV denote coordinates (pixels) in the image at an infinity point in front of the vehicle 1, and KS denotes a distance coefficient (KS=CD/PW).

Accordingly, the position information obtaining unit 162 derives the height from the road surface on the basis of the relative distance of the target portion and the detection distance in the distance image 126 between a point on the road surface located at the same relative distance as the target portion and the target portion.

The specific object provisional determining unit 164 provisionally determines a specific object listed on the specific object table 200 retained in the data retaining unit 152 referring to the luminances and the height of the target object.

More specifically, the specific object provisional determining unit 164 firstly causes the luminance obtaining unit 160 to obtain the luminances of any given target portion in the luminance image 124. Subsequently, the specific object provisional determining unit 164 sequentially selects any specific object from the specific objects registered in the specific object table 200, and determines whether the obtained luminances are included in the luminance range 202 of the specific object sequentially selected. Then, when the luminances are determined to be in the luminance range 202, an identification number representing the specific object is assigned to the target portion so that a specific object map is generated.

The specific object provisional determining unit 164 sequentially executes a series of comparisons between the luminances of the target portions and the luminance range 202 of the specific objects registered in the specific object table 200. The order selecting the specific objects in the specific object table 200 as explained above also shows the order of priority. That is, in the example of the specific object table 200 of FIG. 4, the comparison processing is executed in the following order: “traffic light (red)”, “traffic light (yellow)”, “traffic light (blue)”, “tail lamp (red)”, “turn signal (orange)”, “road sign (red)”, “road sign (blue)”, and “road sign (green)”.

When the comparison is performed according to the above order of priority, and as a result, the luminances of the target portion are determined to be included in the luminance range 202 of a specific object of a high order of priority, the comparison processing is no longer performed for specific objects of a lower order of priority. Therefore, only one identification number representing one specific object is assigned. This is because a plurality of specific objects do not overlap in the real world, and thus a target object that is once determined to be any given specific object is no longer determined to be another specific object. By exclusively treating the target portions in this manner, it is possible to avoid redundant specifying processing for the same target portion that is already provisionally determined to be a specific object, and the processing load can be reduced.

FIG. 6 is an explanatory diagram for explaining a specific object map 210. The specific object map 210 is made by overlaying the identification numbers of the specific objects on the luminance image 124, and the identification number of the specific object is assigned to a position corresponding to the target portion provisionally determined to be the specific object.

For example, in a segment 210a of the specific object map 210, the luminances of target portions 212 corresponding to the tail lamps of the preceding vehicle are included in the luminance range 202 of the specific object “traffic light (red)”, and therefore, an identification number “1” of the specific object “traffic light (red)” is assigned. In a segment 210b of the specific object map 210, the luminances of target portions 214 corresponding to the light-emitting portions at the right side of the traffic light are included in the luminance range 202 of the specific object “traffic light (red)”, and therefore, an identification number “1” of the specific object “traffic light (red)” is assigned. Further, in a segment 210c of the specific object map 210, the luminances of target portions 216 corresponding to the back surface lamp portion of the preceding vehicle are compared with the luminance range 202 of the specific objects “traffic light (red)”, “traffic light (yellow)”, and “traffic light (blue)” in order, and finally, an identification number “4” of the specific object “tail lamp (red)” and an identification number “5” of the specific object “turn signal (orange)” are assigned. FIG. 6 shows a figure in which identification numbers are assigned to target portions of the luminance image 124. This is, however, a conceptual representation for the sake of easy understanding. In reality, identification numbers are registered as data at the target portions.

Subsequently, the specific object provisional determining unit 164 obtains the height from the road surface of the target portion in the specific object map 210 to which the identification number is assigned by the position information obtaining unit 162. Then, the specific object provisional determining unit 164 determines whether the height thereof is included in the height range 204 of the specific object specified with the identification number in the specific object table 200.

For example, in the specific object map 210 as shown in FIG. 6, the identification number “1” is assigned to some segments. Among them, the target portion 214 in the segment 210b has the height of 6 m in the real world, which is derived from the position information obtaining unit 162, and therefore, the height is determined to be included in the height range “4.5 to 7 m” of the specific object “traffic light (red)”. The target portion 212 in the segment 210a has the height of 1 m, and therefore, the height is determined not to be included in the height range “4.5 to 7 m” of the specific object “traffic light (red)”. The target portions determined not to be included in the height range 204 of the specific object are excluded from candidates for the specific object “traffic light (red)”. On the other hand, the target portions determined to be included in the height range 204 of the specific object are provisionally determined to be the specific object “traffic light (red)”.

The grouping unit 166 adopts any given target portion provisionally determined as a base point, and groups the relevant target portions provisionally determined to correspond to a same specific object (attached with a same identification number) of which position differences in the width direction x and in the height direction y are within a predetermined range, thereby making the grouped target portions into a target object. The predetermined range is represented as a distance in the real world, and can be set at any given value.

The grouping unit 166 also adopts the target portion newly added through the grouping processing as a base point and groups the relevant target portions which are provisionally determined to correspond to a same specific object and of which position differences in the width direction x and in the height direction y are within a predetermined range. Consequently, as long as the distance between the target portions provisionally determined to be the same specific object is within the predetermined range, all of such target portions are grouped.

In this case, the grouping unit 166 makes the determination using the distance in the with direction x and the distance in the height direction y in the real world, but when a determination is made using the detection distances in the luminance image 124 and the distance image 126, the threshold value of the predetermined range for grouping is changed according to the relative distance of the target portion. As shown in FIG. 2 and the like, distant objects and close objects are represented in the flat plane in the luminance image 124 and the distance image 126, and therefore, an object located at a distant position is represented in a small (short) size and an object located at a close position is represented in a large (long) size. Therefore, for example, the threshold value of the predetermined range in the luminance image 124 and the distance image 126 is set at a small value for a distant target portion, and set at a large value for a close target portion. Therefore, even when the detection distances are different between a distant position and a close position, the grouping processing can be stably performed.

In addition to the difference in the width direction x and the difference in the height direction y explained above, the grouping unit 166 may group target portions of which relative-distance difference in the depth direction z is within a predetermined range and which are provisionally determined to correspond to a same specific object. In the real world, even when target portions are close to each other in the width direction x and in the height direction y, the positions (relative distances) in the depth direction z thereof may be greatly different. In such case, the target portions belong to different target objects. Therefore, when any one of the difference of positions in the width direction x, the difference of positions in the height direction y, and the difference of positions (relative distances) in the depth direction z is greatly different, the group of the target portion may be deemed as an independent target object. In so doing, it is possible to perform highly accurate grouping processing.

In the above description, each of the difference in the width direction x, the difference in the height direction y and the difference in the depth direction z is independently determined, and only when all of them are included within the predetermined range, the target portions are grouped into the same group. However, grouping processing may be performed using another calculation. For example, when a square mean value √ of the difference in the width direction x, the difference in the height direction y, and the difference in the depth direction z ((difference in the width distance x)²+(difference in the height direction y)²+(difference in the depth direction z)²) is included within a predetermined range, target portions may be grouped into the same group. With such calculation, distances between target portions in the real world can be derived accurately, and therefore, grouping accuracy can be enhanced.

When a target object made as a result of grouping processing by the grouping unit 166 satisfy a predetermined condition, the specific object determining unit 168 determines that the target object is a specific object. For example, as shown in FIG. 4, when the width range 206 is given in the specific object table 200, and the size of a target object is included in the width range 206 of a specific object provisionally determined with regard to the target object on the basis of the specific object table 200, the specific object determining unit 168 determines the target object as the specific object. Here, it is examined whether the target object is of a size adequate to be deemed as a specific object. Therefore, when the size of the target object is not included in the width range 206, the target object can be excluded as information unnecessary for the environment recognition processing.

As a result, the environment recognition device 130 can extract, from the luminance image 124, one or more target objects as specific objects, and the information can be used for various kinds of control. For example, when the specific object “traffic light (red)” is extracted, this indicates that the target object is a fixed object that does not move, and when the target object is a traffic light for the subject vehicle, this indicates that the subject vehicle 1 has to stop or decelerate. When the specific object “tail lamp (red)” is extracted, this indicates that there is a preceding vehicle travelling together with the subject vehicle 1 and that the back surface of the preceding vehicle is at the relative distance of the specific object “tail lamp (red)”.

When a specific object determined by the specific object determining unit 168 is, for example, a “sign” and it is assumed that the specific object indicates a speed limit, the pattern matching unit 170 further executes pattern matching for a numerical value indicated therein, and specifies the numerical value. In this manner, the environment recognition device 130 can recognize the speed limit and the like of the traffic lane in which the subject vehicle is travelling.

In the present embodiment, the specific object determining unit 168 first extracts a plurality of limited specific objects, and then only has to perform the pattern matching only on the extracted specific objects. Therefore, in contrast to the conventional case where pattern matching is performed on the entire surface of the luminance image 124, the processing load is significantly reduced.

### (Environment Recognition Method)

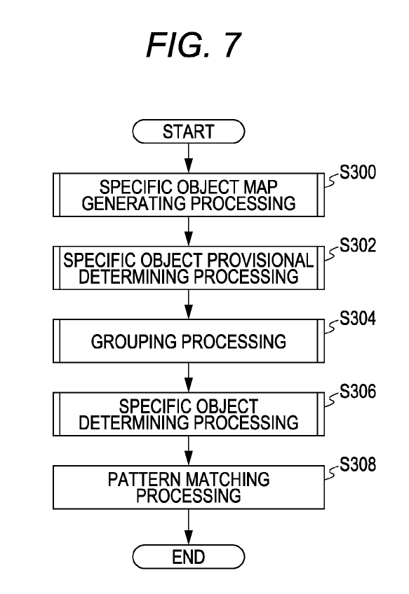

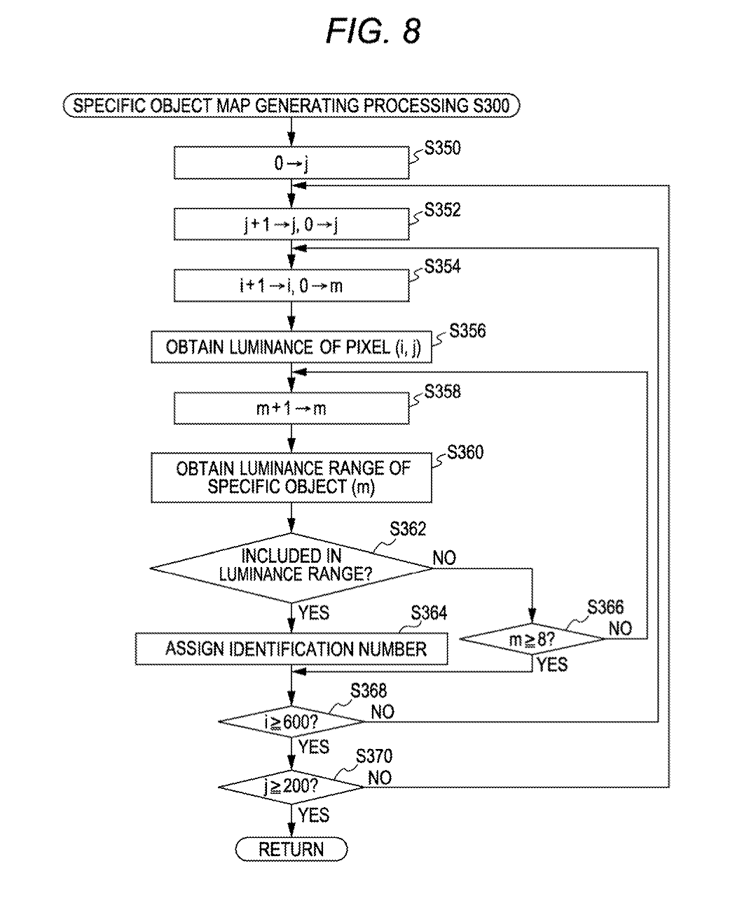

Hereinafter, the particular processings performed by the environment recognition device 130 will be explained based on the flowchart shown in FIGS. 7 to 11. FIG. 7 illustrates an overall flow of interrupt processing when the image processing device 120 transmits the distance image (parallax information) 126. FIGS. 8 to 11 illustrate subroutines therein. In this description, pixels are used as target portions, and the lower left corners of the luminance image 124 and the distance image 126 are origins. The processing is performed according to the environment recognition method in a range of 1 to 600 pixels in the horizontal direction of the image and 1 to 200 pixels in the vertical direction of the image. In this description, the number of specific objects to be checked is assumed to be eight.

As shown in FIG. 7, when an interrupt occurs according to the environment recognition method in response to reception of the distance image 126, the luminance image 124 obtained from the image processing device 120 is referred to, and a specific object map 210 is generated (S300). Then, using the height y of a target portion based on the distance image 126 obtained from the image processing device 120, target portions in the specific object map 210 are provisionally determined as a specific object (S302).

Subsequently, the specific objects provisionally determined are made into a group (S304), and the grouped target objects are determined as a specific object (S306). If it is necessary to further obtain information from the specific object thus determined, the pattern matching unit 170 executes the pattern matching on the specific object (S308). Hereinafter, the above processing will be explained more specifically.

### (Specific Object Map Generating Processing S300)

As shown in FIG. 8, the specific object provisional determining unit 164 initializes (substitutes “0” to) a vertical variable j for specifying a target portion (pixel) (S350). Subsequently, the specific object provisional determining unit 164 adds “1” to (increments by 1) the vertical variable j, and initializes (substitutes “0” to) a horizontal variable i (S352). Then, the specific object provisional determining unit 164 adds “1” to the horizontal variable i, and initializes (substitutes “0” to) a specific object variable m (S354). Here, the horizontal variable i and the vertical variable j are provided to execute the specific object map generating processing on all of the 600×200 pixels, and the specific object variable m is provided to sequentially compare eight specific objects for each pixel.

The specific object provisional determining unit 164 causes the luminance obtaining unit 160 to obtain luminances of a pixel (i, j) as a target portion from the luminance image 124 (S356), adds “1” to the specific object variable m (S358), obtains the luminance range 202 of the specific object (m) (S360), and determines whether or not the luminances of the pixel (i, j) are included in the luminance range 202 of the specific object (m) (S362).

When the luminances of the pixel (i, j) are included in the luminance range 202 of the specific object (m) (YES in S362), the specific object provisional determining unit 164 assigns an identification number p representing the specific object (m) to the pixel so as to be expressed as a pixel (i, j, p) (S364). In this manner, the specific object map 210 is generated, in which a identification number is given to each pixel in the luminance image 124. When the luminances of the pixel (i, j) is not included in the luminance range 202 of the specific object (m) (NO in S362), a determination is made as to whether or not the specific object variable m is equal to or more than 8 which is the maximum number of specific objects (S366). When the specific object variable m is less than the maximum value (NO in S366), the processings are repeated from the increment processing of the specific object variable m in step S358. When the specific object variable m is equal to or more than the maximum value (YES in S366), which means that there is no specific object corresponding to the pixel (i, j), the processing in step S368 subsequent thereto is performed.

Then, the specific object provisional determining unit 164 determines whether or not the horizontal variable i is equal to or more than 600 which is the maximum value of pixel number in the horizontal direction (S368), and when the horizontal variable i is less than the maximum value (NO in S368), the processings are repeated from the increment processing of the horizontal variable i in step S354. When the horizontal variable i is equal to or more than the maximum value (YES in S368), the specific object provisional determining unit 164 determines whether or not the vertical variable j is equal to or more than 200 which is the maximum value of pixel number in the vertical direction(S370). Then, when the vertical variable j is less than the maximum value (NO in S370), the processings are repeated from the increment processing of the vertical variable j in step S352. When the vertical variable j is equal to or more than the maximum value (YES in S370), the specific object map generating processing is terminated.

### (Specific Object Provisional Determining Processing S302)

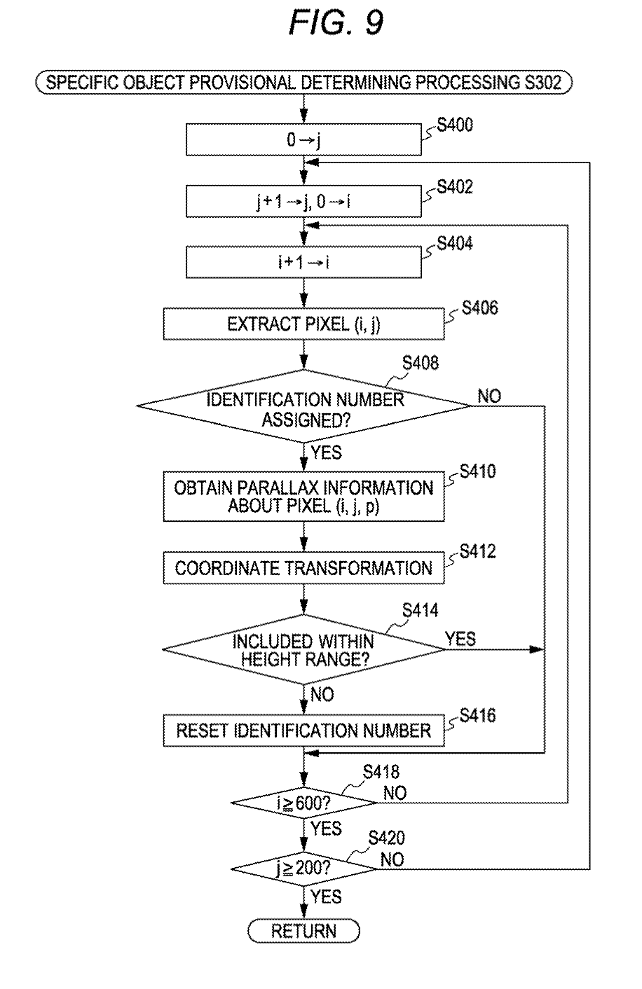

As shown in FIG. 9, the specific object provisional determining unit 164 initializes (substitutes “0” to) a vertical variable j for specifying a target portion (pixel) (S400). Subsequently, the specific object provisional determining unit 164 adds “1” to the vertical variable j, and initializes (substitutes “0” to) a horizontal variable i (S402). Then, the specific object provisional determining unit 164 adds “1” to the horizontal variable i (S404).

The specific object provisional determining unit 164 extracts a pixel. (i, j) as a target portion (S406), and determines whether an identification number p of a specific object is assigned to the pixel (i, j) (S408). When the identification number is assigned (YES in S408), the specific object provisional determining unit 164 causes the position information obtaining unit 162 to obtain parallax information of the distance image 126 corresponding to the pixel (i, j, p) of the luminance image 124 (S410). Then, the specific object provisional determining unit 164 transforms the coordinate of the pixel (i, j, p, dp) including the parallax information dp into a point (x, y, z) in the real world so as to be expressed as a pixel (i, j, p, dp, x, y, z) (S412). At this time, when the parallax information dp is assigned by the block, the same parallax information dp is set in all the pixels in the block. Then, a determination is made as to whether or not the height y of a point in the real world is included in the height range 204 of the specific object represented by the identification number p (S414).

When the height y is not included in the height range 204 of the specific object represented by the identification number p (NO in S414), the specific object provisional determining unit 164 resets (substitutes “0” to) the identification number p assigned to the pixel (i, j, p, dp, x, y, z) so as to expressed as a pixel (i, j, 0, dp, x, y, z) (S416). When the height y is included in the height range 204 of the specific object represented by the identification number p (YES in S414), the identification number is maintained. As a result, the pixel (i, j, p, dp, x, y, z) is provisionally determined as the specific object. When it is determined that the identification number is not assigned (NO in S408), the processing in step S418 subsequent thereto is performed.

Subsequently, the specific object provisional determining unit 164 determines whether or not the horizontal variable i is equal to or more than 600 which is the maximum value of pixel number in the horizontal direction (S418), and when the horizontal variable i is less than the maximum value (NO in S418), the processings are repeated from the increment processing of the horizontal variable i in step S404. When the horizontal variable i is equal to or more than the maximum value (YES in S418), the specific object provisional determining unit 164 determines whether the vertical variable j is equal to or more than 200 which is the maximum value of pixel number in the vertical direction(S420). Then, when the vertical variable j is less than the maximum value (NO in S420), the processings are repeated from the increment processing of the vertical variable j in step S402. When the vertical variable j is equal to or more than the maximum value (YES in S420), the specific object provisional determining processing is terminated. In this manner, the specific object is provisionally determined by the identification number of each pixel in the luminance image 124.

In the above description, the specific object map generating processing and the specific object provisional determining processing are separately performed. However, the two processings can be performed simultaneously in a loop of the horizontal variable i and the vertical variable j.

### (Grouping Processing S304)

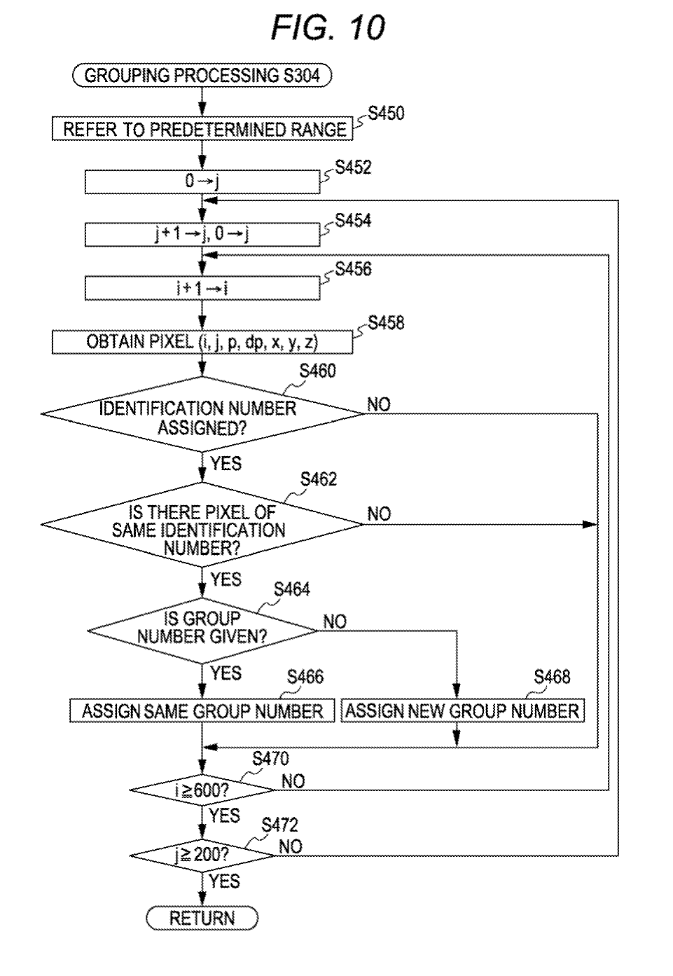

As shown in FIG. 10, the grouping unit 166 refers to the predetermined range to group target portions (S450), and initializes (substitutes “0” to) the vertical variable j for specifying a target portion (pixel) (S452). Subsequently, the grouping unit 166 adds “1” to the vertical variable j, and initializes (substitutes “0” to) the horizontal variable i (S454). Then, the grouping unit 166 adds “1” to the horizontal variable i (S456).

The grouping unit 166 obtains a pixel (i, j, p, dp, x, y, z) as the target portion from the luminance image 124 (S458). Then, a determination is made as to whether an identification number p of the specific object is assigned to the pixel (i, j, p, dp, x, y, z) (S460). When the identification number p is assigned (YES in S460), the grouping unit 166 determines whether or not there is another pixel (i, j, p, dp, x, y, z) assigned the same identification number p within a predetermined range from the coordinate position (x, y, z) in the real world of the pixel (i, j, p, dp, x, y, z) (S462).

When there is another pixel (i, j, p, dp, x, y, z) assigned the same identification number (YES in S462), the grouping unit 166 determines whether the group number g is given to any of all the pixels within the predetermined range including the pixel under determination (S464). When the group number g is given to any of them (YES in S464), the grouping unit 166 assigns a value to all of the pixels included within the predetermined range and all of the pixels to which the same group number g is given, the value being a smaller one of the smallest group number g among the group numbers given thereto or the smallest value of numbers that have not yet used as a group number so as to expressed as a pixel (i, j, p, dp, x, y, z, g) (S466). When the group number g is given to none of them (NO in S464), the smallest value of numbers that have not yet used as a group number is newly assigned to all the pixels within the predetermined range including the pixel under determination (S468).

In this manner, when there is a plurality of target portions that have a same identification number within the predetermined range, grouping process is performed by assigning one group number g. If a group number g is given to none of the plurality of target portions, a new group number g is assigned, and if a group number g is already given to any one of them, the same group number g is assigned to the other target portions. However, when there is a plurality of group numbers g in the plurality of target portions, the group numbers g of all the target portions are replaced with one group number g so as to treat the target portions as one group.

In the above description, the group numbers g of not only all the pixels included within the predetermined range but also all the pixels to which the same group number g is given are changed at a time. The primary reason for this is to avoid dividing the group already unified by changing of the group numbers g. In addition, a smaller one of the smallest group number g or the smallest value of numbers that have not yet used as a group number is employed in order to avoid making a skipped number as much as possible upon group numbering. In so doing, the maximum value of the group number g does not become unnecessarily large, and the processing load can be reduced.

When an identification number p is not assigned (NO in S460), or when there is no other pixel that has the identification number p (NO in S462), the processing in step S470 subsequent thereto is performed.

Subsequently, the grouping unit 166 determines whether or not the horizontal variable i is equal to or more than 600 which is the maximum value of pixel number in the horizontal direction (S470). When the horizontal variable i is less than the maximum value (NO in S470), the processings are repeated from the increment processing of the horizontal variable i in step S456. When the horizontal variable i is equal to or more than the maximum value (YES in S470), the grouping unit 166 determines whether or not the vertical variable j is equal to or more than 200 which is the maximum value of pixel number in the vertical direction (S472). When the vertical variable j is less than the maximum value (NO in S472), the processings are repeated from the increment processing of the vertical variable j in step S454. When the vertical variable j is equal to or more than the maximum value (YES in S472), the grouping processing is terminated.

### (Specific Object Determining Processing S306)

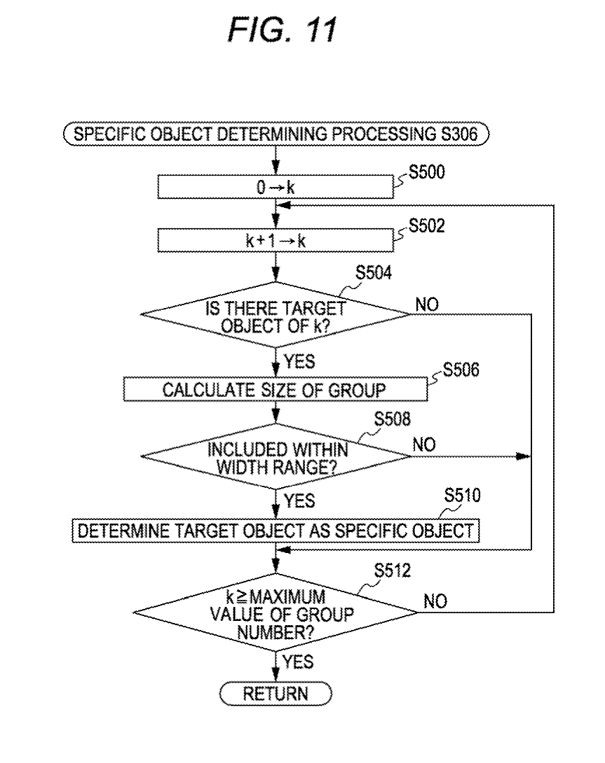

As shown in FIG. 11, the specific object determining unit 168 initializes (substitutes “0” to) a group variable k for specifying a group (S500). Subsequently, the specific object determining unit 168 adds “1” to the group variable k (S502).

The specific object determining unit 168 determines whether or not there is a target object of which group number g is the group variable k from the luminance image 124 (S504). When there is such target object (YES in S504), the specific object determining unit 168 calculates the size of the target object to which the group number g is given (S506). Then, a determination is made as to whether or not the calculated size is included within the width range 206 of a specific object represented by the identification number p assigned to the target object of which group number g is the group variable k (S508).

When the size is included within the width range 206 of the specific object represented by the identification number p (YES in S508), the specific object determining unit 168 determines that the target object is the specific object (S510). When the size is not included within the width range 206 of the specific object represented by the identification number p (NO in S508), or when there is no target object of which group number g is the group variable k (NO in S504), the processing in step S512 subsequent thereto is performed.

Subsequently, the specific object determining unit 168 determines whether or not the group variable k is equal to or more than the maximum value of group number set in the grouping processing (S512). Then, when the group variable k is less than the maximum value (NO in S512), the processings are repeated from the increment processing of the group variable k in step S502. When the group variable k is equal to or more than the maximum value (YES in S512), the specific object determining processing is terminated. As a result, the grouped target objects are formally determined to be the specific object.

As described above, the environment recognition device 130 specifies a target object with a plurality of parameters such as luminances and height. Therefore, the target object is specified in a short time, whereby the efficiency of specifying the target object can be improved. Accordingly, the processing time and the processing load can be reduced.

Furthermore, a specific object is specified only when all of a plurality of conditions such as the luminances and the height or the luminances, the height, and the size are satisfied. Therefore, the accuracy of specifying the target object can be improved.

In addition, a program for allowing a computer to function as the environment recognition device 130 is also provided as well as a storage medium such as a computer-readable flexible disk, a magneto-optical disk, a ROM, a CD, a DVD, a BD storing the program. Here, the program means a data processing function described in any language or description method.

While a preferred embodiment of the present invention has been described hereinabove with reference to the appended drawings, it is to be understood that the present invention is not limited to such embodiment. It will be apparent to those skilled in the art that various changes may be made without departing from the scope of the invention.

In the above embodiment, an example is shown in which, firstly, the luminances of a target portion is exclusively associated with any one of specific objects, and then a determination is made as to whether the height and the size of a target object made by grouping the target portions are appropriate for the specific object or not. However, the present invention is not limited to this. A determination can be made based on any one of the specific object, the luminances, the height, and the size, and the order of determinations may be defined in any order.

In the above embodiment, the three-dimensional position of the target object is derived based on the parallax between image data using the plurality of image capturing devices 110. However, the present invention is not limited to such case. Alternatively, for example, a variety of known distance measuring devices such as a laser radar distance measuring device may be used. In this case, the laser radar distance measuring device emits laser beam to the detection area 122, receives light reflected when the laser beam is irradiated the object, and measures the distance to the object based on the time required for this event.

The above embodiment describes an example in which the position information obtaining unit 162 receives the distance image (parallax information) 126 from the image processing device 120, and generates the three-dimensional position information. However, the present invention is not limited to such case. The image processing device 120 may generate the three-dimensional position information in advance, and the position information obtaining unit 162 may obtain the generated three-dimensional position information. Such a functional distribution can reduce the processing load of the environment recognition device 130.

In the above embodiment, the luminance obtaining unit 160, the position information obtaining unit 162, the specific object provisional determining unit 164, the grouping unit 166, the specific object determining unit 168, and the pattern matching unit 170 are configured to be operated by the central control unit 154 with software. However, the functional units may be configured with hardware.

The specific object determining unit 168 determines a specific object by, for example, whether or not the size of the target object is included within the width range 206 of the specific object. However, the present invention is not limited to such case. The specific object determining unit 168 may determine a specific object when various other conditions are also satisfied. For example, a specific object may be determined when a shift, the relative distance in the width direction x and the height direction y, is substantially constant (continuous) in a target object or when the relative movement speed in the depth direction z is constant. Such a shift of the relative distance in the width direction x and the height direction y in the target object may be specified by linear approximation by the Hough transform or the least squares method.

The steps of the environment recognition method in this specification do not necessarily need to be processed chronologically according to the order described in the flowchart. The steps may be processed in parallel, or may include processings using subroutines.

The present invention can be used for an environment recognition device and an environment recognition method for recognizing a target object based on the luminances of the target object in a detection area.

1. An environment recognition device comprising:
a data retaining unit that retains a range of luminance and a range of height from a road surface in association with a specific object;
a luminance obtaining unit that obtains a luminance of a target portion in a detection area of a luminance image;
a position information obtaining unit that obtains a height of the target portion; and
a specific object provisional determining unit that provisionally determines the specific object corresponding to the target portion from the luminance and the height of the target portion on the basis of the association retained in the data retaining unit.

2. The environment recognition device according to claim 1, wherein the position information obtaining unit obtains a distance image, which is associated with the detection area of the luminance image and in which a relative distance of a target portion in the detection area with respect to a subject vehicle, and derives the height of the target portion on the basis of the relative distance of the target portion and a detection distance in the distance image between a point on a road surface located at the same relative distance as the target portion and the target portion.

3. The environment recognition device according to claim 1 further comprising:
a grouping unit that groups target portions of which position differences in the width direction and in the height direction are within a predetermined range and which are provisionally determined to correspond to a same specific object into a target object; and
a specific object determining unit that determines the target object is the specific object.

4. The environment recognition device according to claim 2 further comprising:
a grouping unit that groups target portions of which position differences in the width direction and in the height direction are within a predetermined range and which are provisionally determined to correspond to a same specific object into a target object; and
a specific object determining unit that determines the target object is the specific object.

5. The environment recognition device according to claim 3, wherein the grouping unit groups target portions of which relative-distance difference is within a predetermined range and which are provisionally determined to correspond to a same specific object.

6. The environment recognition device according to claim 4, wherein the grouping unit groups target portions of which relative-distance difference is within a predetermined range and which are provisionally determined to correspond to a same specific object.

7. The environment recognition device according to claim 3, wherein:
the data retaining unit further retains a range of size in association with the specific object,
the specific object determining unit determines that the target object is the specific object according to the size of the target object on the basis of the association retained in the data retaining unit.

8. The environment recognition device according to claim 4, wherein:
the data retaining unit further retains a range of size in association with the specific object,
the specific object determining unit determines that the target object is the specific object according to the size of the target object on the basis of the association retained in the data retaining unit.

9. The environment recognition device according to claim 5, wherein:
the data retaining unit further retains a range of size in association with the specific object,
the specific object determining unit determines that the target object is the specific object according to the size of the target object on the basis of the association retained in the data retaining unit.

10. The environment recognition device according to claim 6, wherein:
the data retaining unit further retains a range of size in association with the specific object,
the specific object determining unit determines that the target object is the specific object according to the size of the target object on the basis of the association retained in the data retaining unit.

11. The environment recognition device according to claim 3, wherein the specific object provisional determining unit determines whether or not one of the specific objects sequentially selected from a plurality of specific objects corresponds to each of target portions, and provisionally determines a specific object to the target portion.

12. The environment recognition device according to claim 4, wherein the specific object provisional determining unit determines whether or not one of the specific objects sequentially selected from a plurality of specific objects corresponds to each of target portions, and provisionally determines a specific object corresponding to the target portion.

13. The environment recognition device according to claim 5, wherein the specific object provisional determining unit determines whether or not one of the specific objects sequentially selected from a plurality of specific objects corresponds to each of target portions, and provisionally determines a specific object corresponding to the target portion.

14. The environment recognition device according to claim 6, wherein the specific object provisional determining unit determines whether or not one of the specific objects sequentially selected from a plurality of specific objects corresponds to each of target portions, and provisionally determines a specific object corresponding to the target portion.

15. An environment recognition method comprising:
obtaining a luminance of a target portion in a detection area of a luminance image;
obtaining a height of the target portion; and
provisionally determining a specific object corresponding to the target portion from the luminance and the height of the target portion based on the association of a range of luminance and a range of height from a road surface according to the specific object, which is retained in a data retaining unit.
